(19) United States
(12) Patent Application Publication
(10) Pub. No.: US 2013/0339076 A1
(43) Pub. Date: Dec. 19, 2013

(54) GEOCODING POINTS OF INTEREST AND SERVICE ROUTE DELIVERY AND AUDIT FIELD PERFORMANCE AND SALES METHOD AND APPARATUS

(71) Applicant: Alfredo Velázquez Baranda, Col. Palo Alto (MX)

(72) Inventor: Alfredo Velázquez Baranda, Col. Palo Alto (MX)

(21) Appl. No.: 13/512,906

(22) PCT Filed: Feb. 1, 2012
(86) PCT No.: PCT/US12/00051

§ 371 Date: May 31, 2012

(51) Int. Cl. G06Q 10/04

(52) U.S. Cl. CPC G06Q 10/047
USPC 705/7.17

(57) ABSTRACT

A computer guided geocoded route service sales and deliveries method and apparatus optimizing geomarketing, financial and sales, and improved logistics along delivery routes using operator transmitters/receivers inputs of route information in one mode, which receive and display to the operator in another mode computer generated pricing, sales, financial and marketing information, optimal routes, and other related information concerning each customer and distribution point of interest along a route, which are displayed or not, to the operator as he/she reaches the particular latitude and longitude of a point of interest enforcing the operator to act as it is indicated.

### BACKGROUND OF THE INVENTION

1. Field

This invention deals with service route delivery optimization methods. In particular, it relates to a cloud computer method that improves market definition and segmentation methods, integrates such results for route delivery and optimization utilizing “Geomatics,” also known as geospatial technology or geomatics engineering, (the discipline of gathering, storing, processing, and delivering geographic information, or spatially referenced information) in several business processes, such as auditing the delivery, sale and payment processes creating the basis for cash less and electronic cash transfers procedures, geocoding, routing, tracking, advertising and promotional efforts, safety and security concerns, as well as setting the fundamental capabilities for cash collection, credit assignment, and electronic cash transfers.

2. State of the Art

Various geocoding methods and apparatus are known. For example, Santoro et al., U.S. Pat. No. 8,010,407 issued Aug. 30, 2011 discloses a business finder for locating local businesses to contact using computer implemented methodology within a geographical target area. Nesbitt et al., U.S. Pat. No. 7,920,965 issued Apr. 5, 2011 identifies routes configured to travel through multiple points of interest using a computer implemented method. Staffaroni et al., U.S. Pat. No. 8,005,488 issued Aug. 23, 2011 discloses an automatic service vehicle hauling and dispatch system and method for improving efficiency and operation of a fleet of taxis or service vehicles dispatched to a pickup location using automatic speech recognition and/or radiolocation technology. Prabhakaran, U.S. Pat. No. 5,922,040 issued Jul. 13, 1999 discloses a method and apparatus for fleet management using a system of geographical user interface apparatus associated with a main process manager through a central processor. Associated child processors are in communication with the central processor coupled to a mobile information center to provide vehicle position data and the like to track trucks for fleet management.

These geocoding systems emphasize logistics improvements, business location service, fleet management, routing design, but none encompasses an integrated cloud service computer method to centrally audit and control on site sales, advertising and promotional efforts, route engineering, payment collection continually upgraded and adapted to a client's particular needs and location, along with real time evaluation of an operator's performance along his route.

The integrated IT method and cloud service apparatus described below provides an improved field audit smart technology system (F.A.S.T.) for companies or particulars that deliver goods and services while at the same time allows for recording the location of customers, points of marketing interest, input relevant marketing data, receive sales updates and instructions to optimize sales and logistical deliveries, design the perfect volume and portfolio mix of products and builds a real time business intelligence capability.

### SUMMARY OF THE INVENTION

The invention comprises a computer method that updates and corrects customer delivery route point of interest data bases using coordinates, allowing sales representatives to perform real time field audits to design and correct allocations of volume and product mix for diverse clientele. It further improves the distribution process by automating route engineering, providing navigation capabilities along with the detection of additional potential customer points of interest (POI) along a route; providing personalized customer advertising and promotional campaigns, and a basis for cash management or cashless management processes.

It comprises:

a. providing route delivery and sales operators of delivery vehicles with computer signal transmitters/receivers, which in one mode allows the operator to record latitude and longitude coordinates of customers and other POI visited, along with sales information, delivery information, client information, and other marketing information concerning customer points of interest along an operator's route, and in another mode receives and displays to the operator customized real time location, pricing, safety, security and marketing information, optimal routes, and other related information concerning each customer business model as the operator reaches the particular latitude and longitude of the clients of the customer being served.

b. providing a computer signal interface to receive and transmit all kind of geocoded information to and from the signal transmitters/receivers to a owned server, clients and third party computer servers and/or data bases.

c. inputting a geocoded computer program into the computer server to computer translate the geocoded signals by selective marketing criteria for each point of interest to generate a customized marketing mix and sales program for said points of interest along with optimal distribution system and routing information; and

d. transmitting the customized marketing and sales program and optimal distribution system and routing information to the route delivery and sales operators' mobile computers signal transmitters/receivers for separate display as the operator reaches each customer point of interest.

Additional features of the computer method include:

Depicting the customized marketing and sales program to the final customer.

Recording market information (the responses for instance of the marketing and or sale effort.

Capturing and transmitting the commercial transaction (the sale, credit assignment, deferral, etc.) as well as receiving, prosecuting, web portraying and depicting of business intelligence information to all audiences.

Determining how business decisions are made and how they are transmitted back to the mobile computers to start all over again.

As used herein, the term F.A.S.T. is a cloud computing service that allows participants to integrate the following business processes in one vertical scheme:

1. Geocode clients—obtain the coordinates of any point of interest on a daily basis, update or “clean” the data base for clients and generate opinion census at the same time.

2. Operate with intelligence—route engineering, dynamic routing and balance logistics capabilities along with GIS (Geographic Information Systems) analysis for marketing and sales optimizations.

3. Audit driving and sales performance in the field—The platform acts in real time to record and report not only where a driver is, but also his work performance efficiency and effectiveness.

4. Understand the market—obtain information not only about clients being served but also, about the market and economic activities that happen in a geographic region.

5. Create and report by exception—data is presented through dynamic and “layer” or sliced schema that depicts selected useful information in different types of mobile devices as well as on the world wide web system of interlinked hypertext documents accessed via the Internet.

6. Facilitate business decision processes providing and relating an exact location to all kind of social and business activities done or recorded during the daily operation of the routes and, creating a channel of communication to deploy those geo-supported decision making processes in real time.

These interactive exchange capabilities result in cost reductions, increased sales, environmental, safety and security improvements, and new business models for clients.

The information obtained in the geocoding process is used primarily for a) geomarketing and sales activities and b) optimizing logistics sales and delivery and c) for risk analysis processes in which a credit will be given or denied. The geocoded coordinates used for geomarketing and sales upgrade, once it has recorded a sufficient sample to eliminate any possible man made or technology made mistake, can produce the right client address that is used either to build or correct (clean) a client database. On average thirty percent or more of the client information in the client data base has errors or in congruencies, which cause marketing and sales mistakes.

The geocoding coordinates of all clients, destinations, and the location of distribution centers as well as the product information, resources and the like involved in daily muting are inputted into a client data base and used to optimize logistics using computer algorithms to create new delivery zones and route sequence for each client. These updated itineraries are then transmitted to the mobile receivers of sales and delivery operators. The mobile receivers display in real time the optimal routes to service each client on an operator's route, allowing them to complete on average 5% to 30% more client visits per day.

The operator's receivers continuously record and store the location, speed, and other relevant information until it is time to send it to upgrade the business intelligence platform and the client data base. This upgraded client information is transmitted to the client data base using data transmission technology supported by any mobile phone carrier. The upgraded client data base is then inputted and stored in a Smartmaps FAST (SF) central server, often in real time. Typical information sent includes not only the location, but also information regarding the activities performed by the operator on his daily route such as sales information, photos, videos, messages, texts, contracts, interviews, census, all economical transactions, cash flows and credit solicitudes among many others.

The SF central server then processes the geocoded information via a navigational—marketing—selling and auditing featured computer program cloud computer program such as that program produced by Mapas Inteligentes S.A. de C.V. known as Smartmaps FAST in accordance with selected parameters of interest to provide value added services. The SF central server then uploads the processed information to a dedicated WEB page for each client in which auditing, sales, interviews or other information is presented either in a raw data format or a processed format, creating a business intelligence platform that can be consulted and viewed by different users. A third party or a providing computer server may be used to store the WEB page for selective access. The review of the WEB page information provided for an individual client can be conducted at different levels, depending upon clearance authorization. For example, operators receive only relevant information regarding client routing and sales, whereas company managers and CEO's have access to overall marketing trends, marketing strategies, profit margins, costs, routing efficiency, etc. often in real time.

Once decisions have been made by company managers and CEO's reviewing the updated processed format, these decisions can be downloaded to the operator's mobile receivers in real time. Changing prices, product promotions, credit terms, contract revisions, and other data altered by new business models is continually forwarded to operators for immediate implementation along their respective client routes. This allows personalized pricing offers, credit, promotions, contract changes, etc. to be offered to each client so that these personalized services are offered without the intervention of the operator as a decision matrix algorithm is used to assign respective offers to each client bearing in mind its particular location. Thus more efficient and personalized marketing controls of client goods and service delivery is provided as the operator's mobile receiver will only display these terms when an operator is at an assigned location, usually a particular client. This avoids the problem of supervising and control of marketing based offers, etc. as these offers are pre-authorized and only provided for a particular client.

The present field audit smart technology method and apparatus is thus a dynamic interactive computer guided system providing customized geomarketing and sales instructions while at the same time, optimizing logistic goods and service deliveries as well as credit allocation and cash flow management. The sum of subsequent and inter related processes in which every step is part of bigger processes that integrate into more parts. The sum of these parts produces more value, although it is not mandatory to employ all of them. Every client is thus at different stages in the system, and consequently uses the services differently.

The present method geocoding goods and service route sales and delivery thus provides an improved field audit smart technology system for goods and services sales and delivery vehicle operators to record the location of customer points of marketing interest, along with relevant marketing data in one mode, and receive sales updates and instructions in another mode to optimize sales and logistical deliveries for goods and services product marketing and sales to points of interest along the route as well as, receives credit or other financial solicitudes, sends them to a remote proprietary or owned server where a risk analysis algorithm computes its restriction bearing the exact location of the origin of the solicitude and emits a response that is then received and acknowledge.

### DESCRIPTION OF THE DRAWINGS

FIG. 1 is a flow chart of one embodiment of the method of the invention.

FIG. 2 is a schematic layout of a typical embodiment of the apparatus to implement the method of the invention.

FIG. 3 illustrates a handheld transmitter/receiver response as an operator approaches a point of sale.

FIGS. 4, 4a, 4b, and 4c illustrate a handheld transmitter/receiver display inside a client geo fence for various clients and their sales activities.

FIG. 5 illustrates a handheld response as an operator leaves a client geofence.

FIG. 6 illustrates how the handheld transmitter/receiver uses GPS for location services.

FIGS. 7, 7a, and 7b illustrate an example of how the handheld transmitter/receiver operates inside a client's geo fence to provide credit to a customer.

FIG. 8 illustrates the response of the handheld transmitter/receiver as an operator leaves a client's geo fence tracing a new route to the next point of sale.

FIG. 9 again illustrates a handheld transmitter/receiver approaching a client's geo fence for use as a display location to guide the operator to each point of sale.

FIGS. 10 and 10a illustrate the display sales responses on the screens when the transmitter/receiver is inside the client's geo fence.

FIG. 11 illustrates the response of the handheld transmitter/receiver as an operator leaves a client's geo fence tracing a new route to the next point of sale.

FIGS. 12-21 illustrate a schematic of the types of reports, which can be generated by the server to aid a manager or an operator in the field including a method for volume and portfolio mix as well as a real time decision taking

### DESCRIPTION OF THE ILLUSTRATED EMBODIMENTS

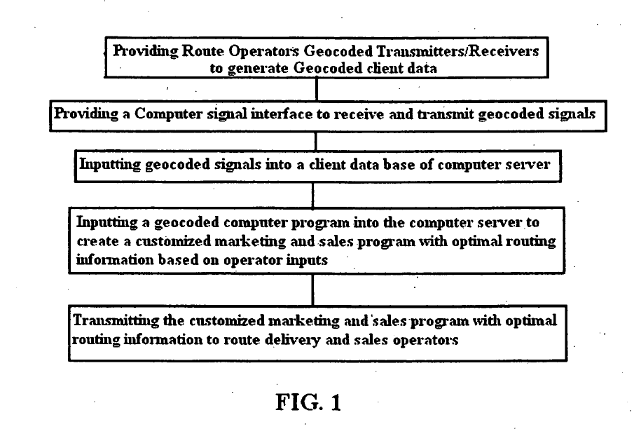

FIG. 1 is a flow chart of one embodiment of the method of the invention showing a typical sequencing. As shown in FIG. 1, the method provides route operators geocoded transmitters/receivers to generate and input geocoded client data. This geocoded client data is transmitted via a computer signal interface, such as blue tooth, WIFI, GPRS, mobile phone networks, etc. to the client data base of a computer server. A geocoded computer program (not shown) is inputted into the computer server to create a customized marketing and sales program with optimal routing information based on the operator inputs in the client data base. The customized marketing and sales program with optimal routing information is then transmitted via a web cloud to the route delivery and sales operators.

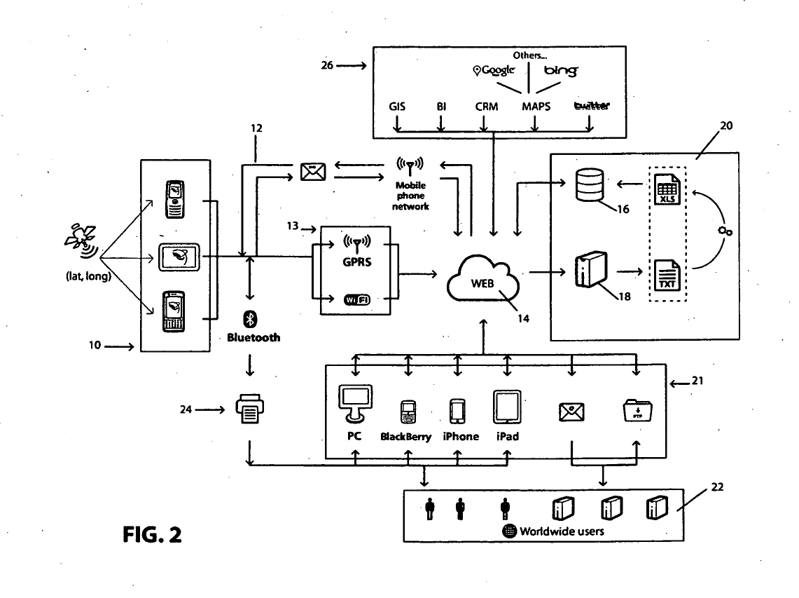

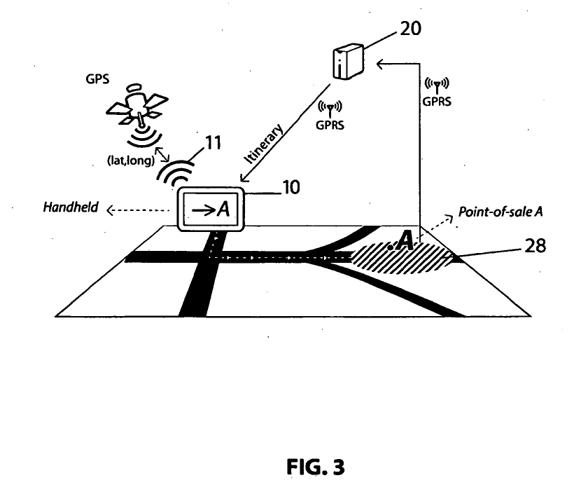

FIG. 2 is a schematic layout of a typical embodiment of the apparatus to implement the method of the invention. A plurality of computer interactive data transmitters and GPS receivers 10 are provided to route delivery and sales operators to transmit operator inputted geocoded signals of client data tied to latitude and longitude of a client or distribution points of interest via Global Positioning System interfaces 11 shown in FIG. 3. These interactive data transmitters and GPS receivers 10 are used by sales and delivery operators driving delivery service vehicles (not shown) to input data regarding their clients as they visit and deliver goods and services along their customer routes. Typically, the current location of a client is inputted along with marketing and sales information and delivery times and periodically transmitted via computer signal interfaces 13, such as mobile phone networks, GPRS, WIFI, to a WEB cloud 14 to a proprietary server 18 and data base 16, hosted in a secure location 20. (Smartmaps G15)

The secure server 20 is programmed and controlled via a computer program such as that program produced by Mapas Inteligentes S.A. de C.V. under the name FAST to process the client captured data base 16 inputs in accordance with selected parameters of interest to provide value added services. The secure server 20 then uploads the processed information to a clients' dedicated WEB cloud service 14 that in exchange, can be consumed by individuals or machines worldwide 22 via all kind of mobile devices such as blackberries, iPhones, iPads, etc, and personal computers, mail or FTP services 21. 24 In addition the dedicated WEB pages can be enhanced by a series of proprietary or third party content or services such as Google maps, social networks like Twitter or Facebook, Geographic Information Systems, Customer Relationship Management, Business Intelligence, etcetera 26.

This review of the information provided for an individual client can be conducted at different levels, depending upon clearance authorization. For example, operators receive only relevant information regarding client routing and sales, whereas company managers and CEO's have access to overall marketing trends, marketing strategies, profit margins, costs, routing efficiency, etc. often in real time.

As route sales and delivery operators visit their clients, they continually record the correct locations constantly updating the client data base, along with other sales and product information.

The information obtained in the geocoding process is used primarily as described above. The address that corresponds to each pair of coordinates can be derived from any geocoded map service 26 such as Google Maps or Bing, shown in FIG. 2. 26

The operator's transmitters/receivers 10 continuously record and store the location, speed, and other relevant information until it is time to send it to upgrade the client WEB service and/or data base. This upgraded client information is transmitted to the client data base using data transmission technology supported by any mobile phone carrier.

FIG. 3 shows a handheld transmitter/receiver 10 response as it approaches a client geo fence 28. The handheld operator transmitter/receiver 10 wirelessly downloads the list of points of sale to be visited, the itinerary, the tracking of which is then recorded using their GPS location. A navigation system is also used to guide the operator to each point of sale. Once the handheld crosses de geofence an alert is sent to the secure server and several customized per client functions (not shown) are activated within the mobile device, the WEB platform and the server.

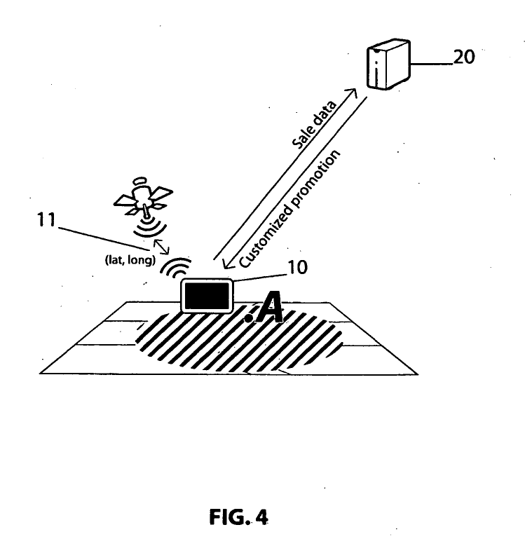

FIG. 4a illustrates the response of a handheld transmitter/receiver 10 inside a client geo fence 28, where it switches to display a proximity list FIG. 4a of lists of the points of sale within reach via screen display 10. It usually includes proximity indicators as shown. When the handheld transmitter/receiver 10 is less than “X” meters (configured by the client) from a corresponding point of sale, it automatically allows the assigned activity, for instance a sale, to that particular client and when needed, prompts the server 20 for authorization to present a particular information, for instance a customized promotion or advertising on its display The handheld transmitter/receiver 10 records the exact time and location when the cust FIG. 4b. omized ad is played for a customer as shown in FIG. 4b, and uploads this data along with the result of the sale effort to the server 20. The add window shown in FIG. 4b on the display 22 illustrates special advertising customized and only shown to a particular client-A.

Once the promotion or ad is displayed on the display screen 22, the handheld transmitter/receiver 10 screen FIG. 4c switches to a sale screen to allow the capture of the sale as shown in FIG. 4c, which is a typical sale window for point of sale A.

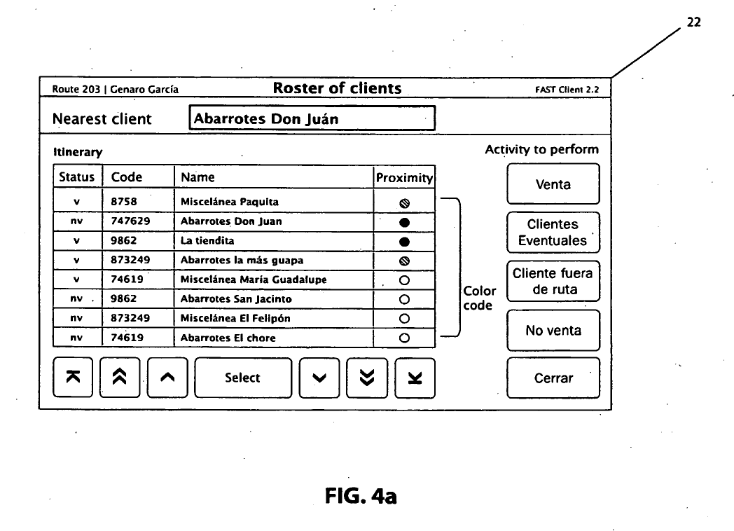

FIG. 5 illustrates the response of the handheld transmitter/receiver 10 as an operator leaves a client's geo fence 28. The handhold transmitter/receiver 10 traces a new route to the next point of sale B. When the handheld transmitter/receiver 10 enters the new client's geofence 29, it automatically repeats the display sequence for the new client.

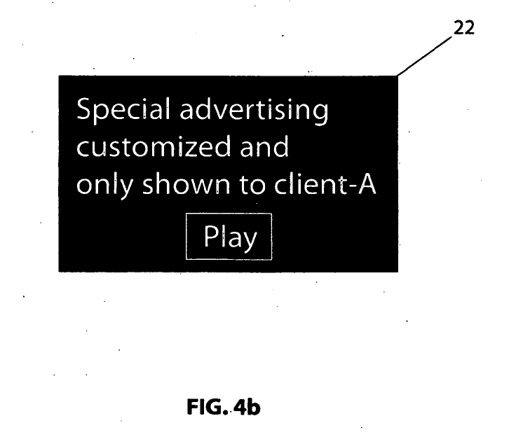

FIG. 6 illustrates how the handheld transmitter/receiver 10 uses GPS for location services. The handheld transmitter/receiver 10 wirelessly downloads the list of points of sale to be visited. The transmitter/receiver 10 then uses its GPS location and navigation system to guide the operator to each point of sale.

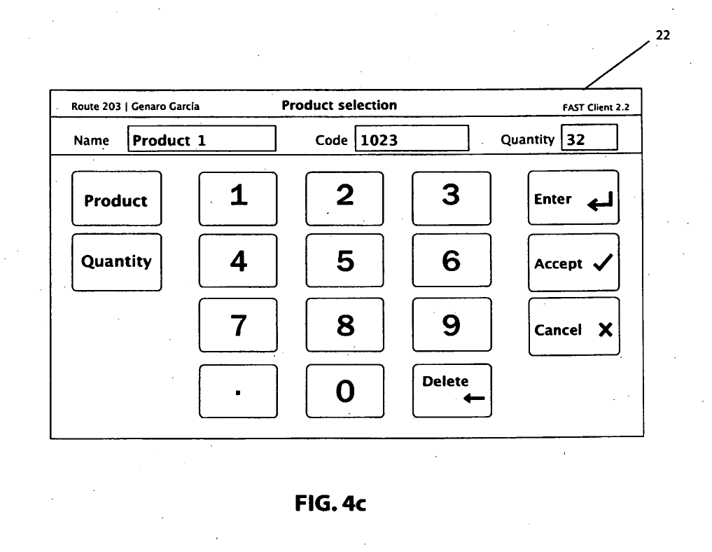

FIG. 7 illustrates an example of how the handheld transmitter/receiver 10 operates inside a client's geo fence to provide credit to a customer. The display 22 switches to display the roster of clients depicting their distance from each operator via color code proximity indicator 30 representing differing distances to each client. The operator will be allowed to select only those clients that are “X” meters from the current position Fig As shown in FIG. 7a, the operator selects from the list and enters client sales activities on display 22 once the operator has gone through the promotional and sale activities. At that point, the operator will be allowed to select the Credit button FIG. 7a. and the handheld transmitter/receiver 10 will automatically prompt the server 20 for authorization to depict a customized credit proposal (credit solicitude) window FIG. 7b 22. The handheld transmitter/receiver 10 then records the exact time and location when the credit proposal was made and sends it to the secure server 20. With this.

As shown in FIG. 7b, if credit is to be solicited, display screen 22 is activated sending the sale data to the server 20, which runs algorithms including risk assessment analysis that considers recent economic geographic and socio-demographic data to determine client approval and amount of credit authorized, or otherwise refuses credit. The result of the risk analysis is then sent to a third party lender, such as a bank or financial institution, via the third party server 32 that will decide whether or not to authorize the credit solicitation and responds with a unique identification number. The server 20 than acknowledges the receipt of the information from the bank and transmits its decision to the operator's transmitter/receiver 10.

The screen 22 then displays the result of the solicitation by prompting, if positive, requesting the customer to plug in a unique code previously given to the customer (the token). Once the token is captured, the server 20 sends acknowledgments to all interested parties.

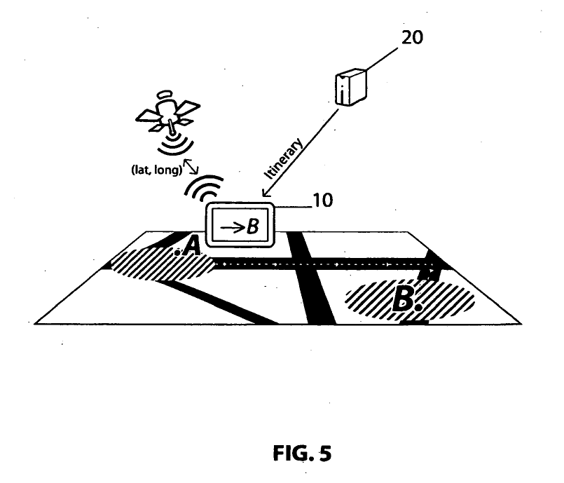

FIG. 8 illustrates the response of the handheld transmitter/receiver 10 as an operator leaves a client's geo fence 28 tracing a new route to the next point of sale B. When the handheld transmitter/receiver 10 enters the new client's geo fence, it automatically repeats the display credit sequence for the new client.

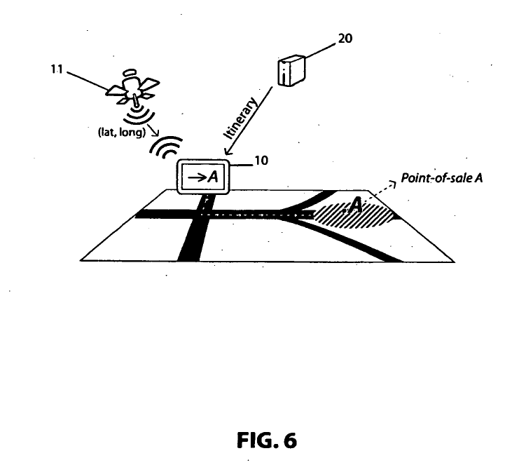

FIG. 9 again illustrates a handheld transmitter/receiver 10 approaching a client's geo fence 28 for use as a display location to guide the operator to each point of sale.

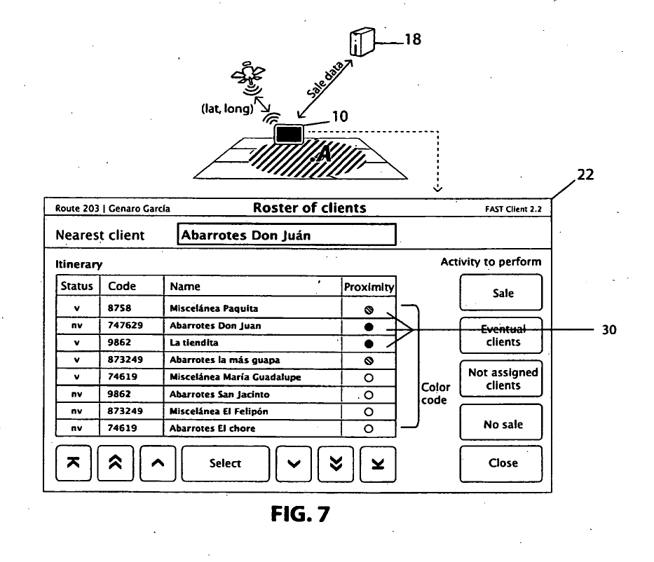

FIG. 10 illustrates the display response on the screen 22 when the transmitter/receiver 10 is inside the client's geo fence. A list, of points of sale within reach is then displayed, alone with the distance or proximity of each point of sale. Usually, only clients within a certain distance are displayed on the screen 22 in color so that the operator can select those closest of interest from the list. Once the operator selects a client, as shown in FIG. 10a, a second screen 22 appears allowing the operator to capture data as to client sales. This sales information is confirmed on a third screen 22 and transmitted to the server 20.

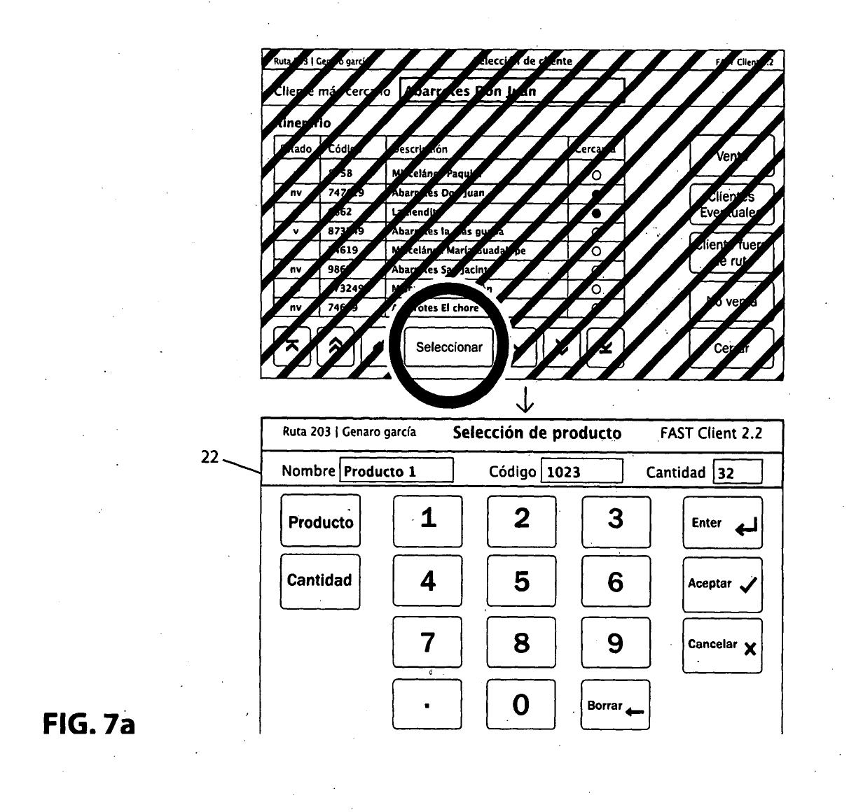

FIG. 11 illustrates the response of the handheld transmitter/receiver 10 as an operator leaves a client's geo fence 28 tracing a new route to the next point of sale B. When the handheld transmitter/receiver 10 enters the new client B's geo fence 28, it automatically repeats the display sales sequence for the new client.

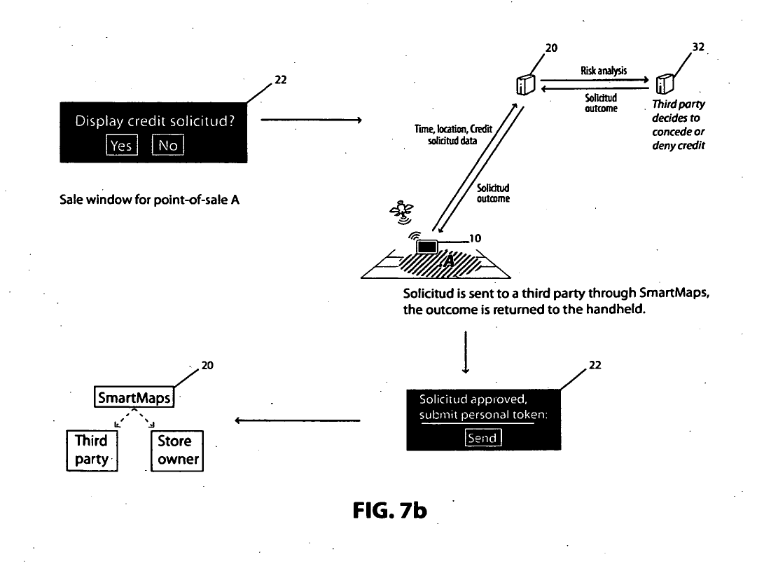

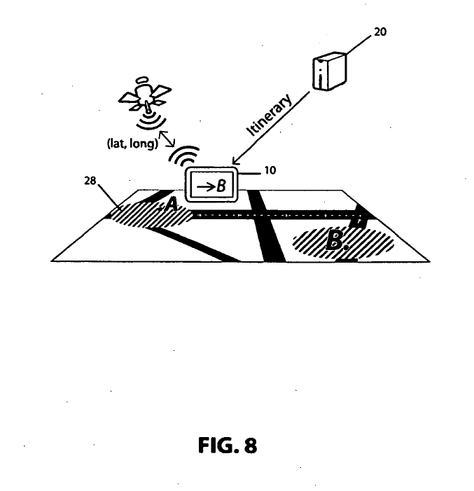

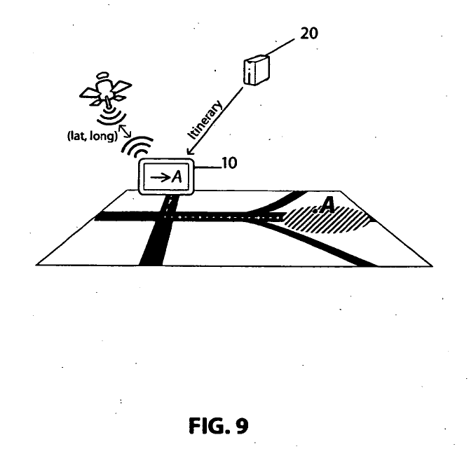

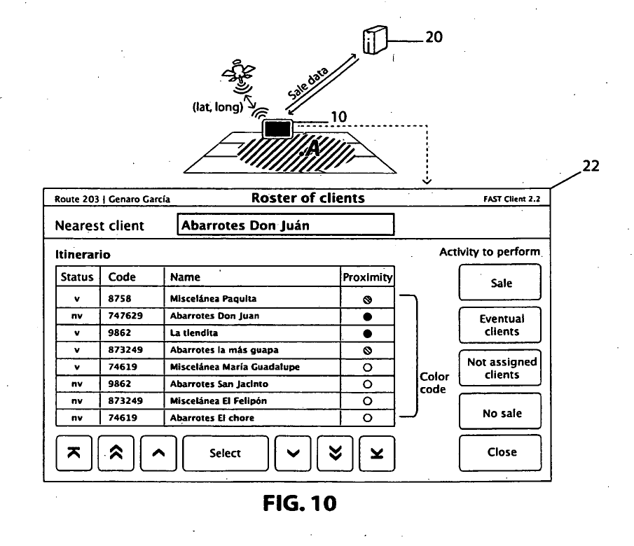

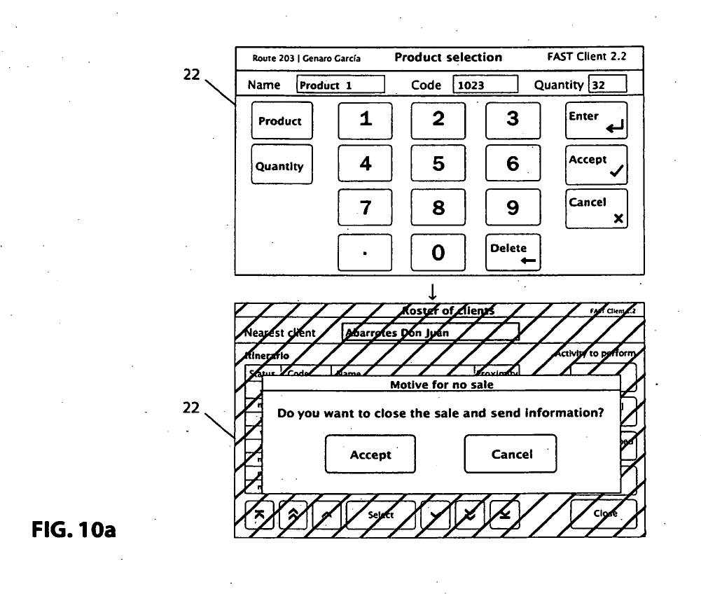

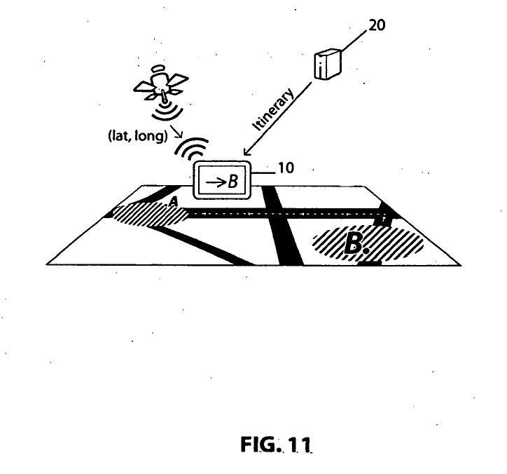

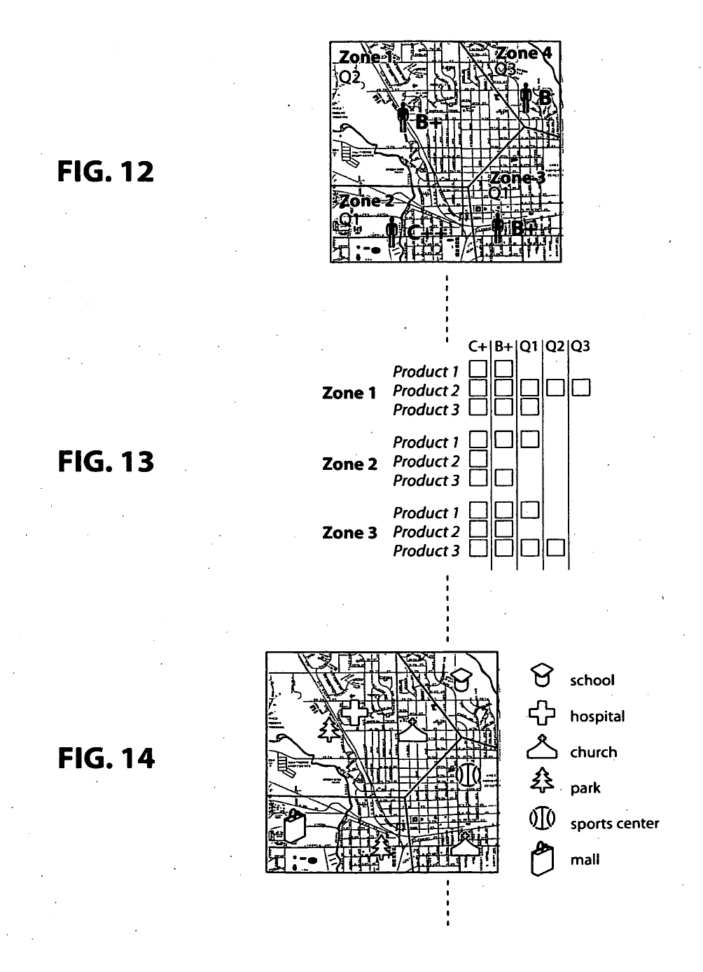

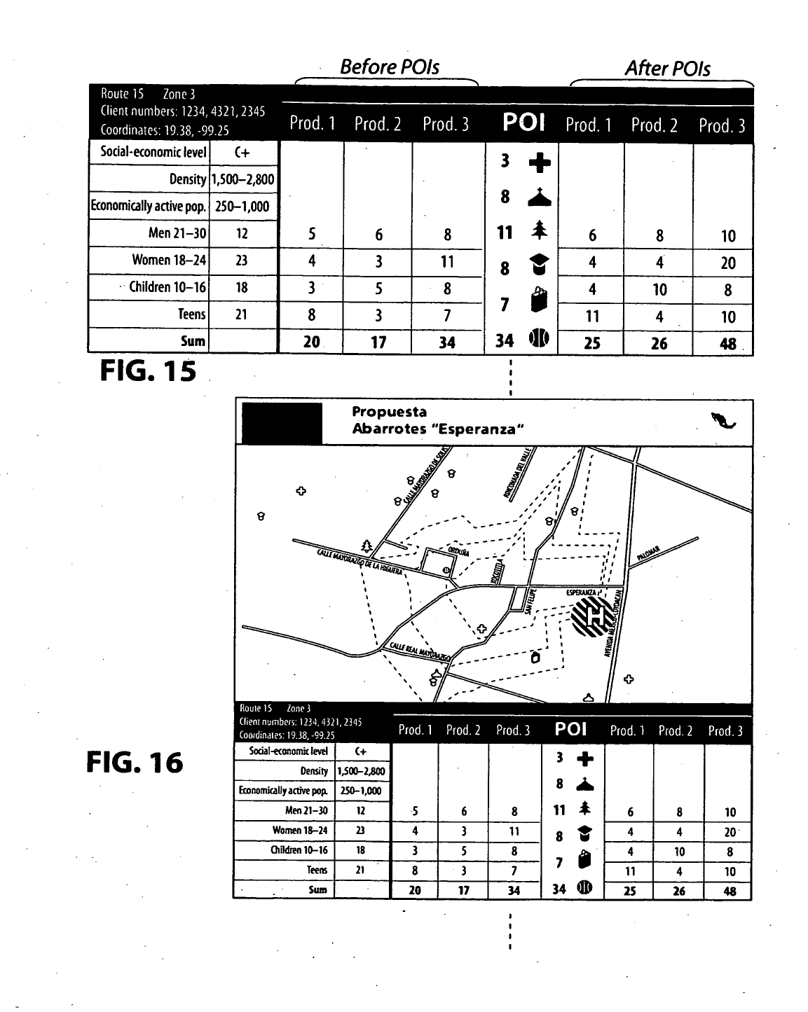

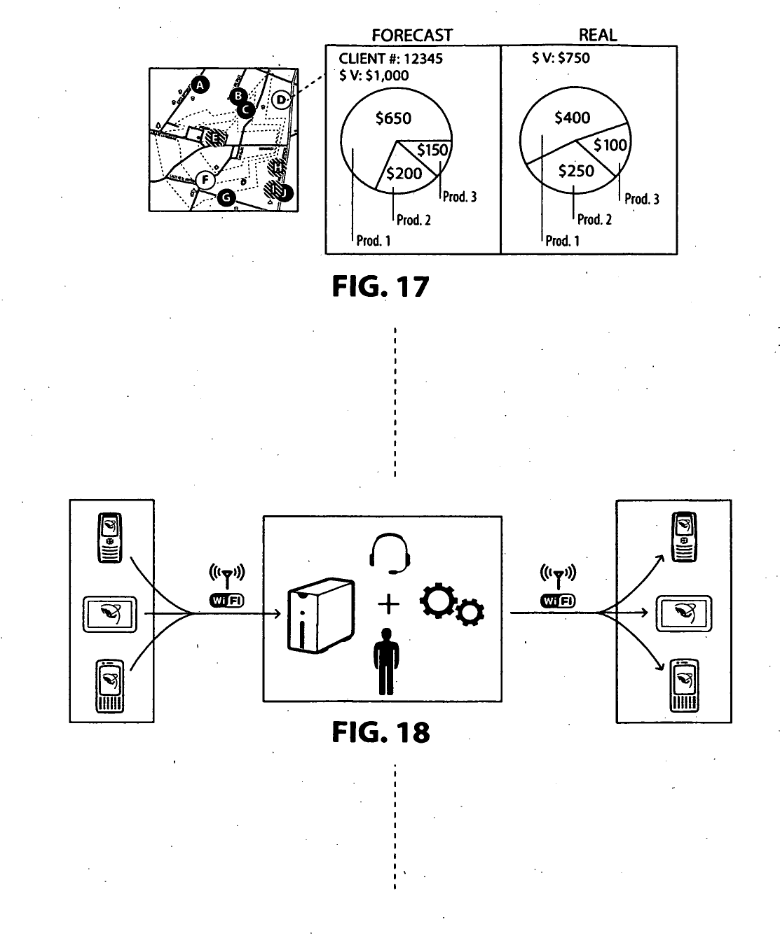

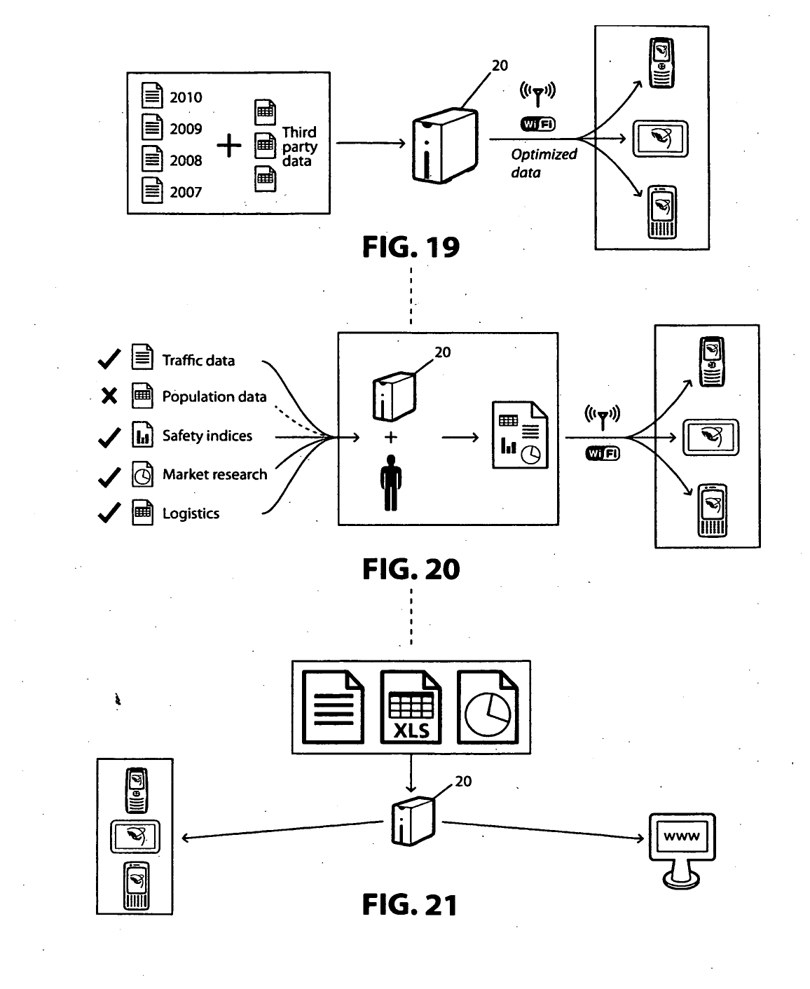

FIGS. 12-21 illustrate a method to analyze understand and develop a marketing mix strategy that connects its execution with the previous field audit processes presented before. for display on various screens 22 As shown in FIG. 12, previously defined distribution zones that were designed considering several logistics restrictions such as quantity of clients to be visited, distance or time from the distribution center, product or margin volume assigned, etc. in which then, basic socio-demographic, economic and geographical public information is then incorporated as the first step of the method. For each created zone, geo-market research then estimates demand for a certain portfolio of products within each zone as shown in FIG. 13. This estimation is done by building a matrix in which in the files a roster of products with its assigned market definition is matched with the socio-demographic, economic and geographical information found in each zone, presented in the columns, hence creating a expected demand for each product in each zone. In FIG. 14, the presence of certain landmarks like schools, churches, hospitals, parks, sport centers or malls among many others, recorded as points of interest in the previous steps by the operator with the mobile devices, are considered as part of the method as they can affect the demand of products in any given zone. The completed volume and portfolio matrix is then improved considering the presence of such these points of interest as they are taken into account to enhance or diminish product demand in each zone as shown in FIG. 15. A composite map is then generated by the server for each zone and printed and/or pushed to be displayed on the screens 22 to be shown by the sales representative to a shop owner or customer depicting the suggested volume and portfolio mix for each product as shown in FIG. 16. The proposed volume and portfolio mix will be used by the operators as their sales objective to be reached within a certain period of time; from here, the rest of the clients organization will construct their own sales, marketing and any other management schemas of control and recognition called Geo-management. FIG. 17 shows how the possible differences between designed and expected sales and volume mix against real accomplishments in the field by the operators, is first transmitted and then compared to create in real time a colored code map portraying the results of the effort. This information is gathered on a daily basis by the sales representative in real time regarding consumption, inventories, competence, owners' opinions, etc. and then transmitted to the server 20. To feed the real time auditing and managerial schemas. FIG. 18 illustrates how market, sale and operating information is received in a war room or command center or a call center, in which route supervisors, managers and directives receive, analyze and take decisions. Such decisions are then sent back in real time to the field through the WEB and the GPRS, GSM connections used by the mobile devices. FIG. 19 illustrates how previous research information, third party information and historic collected data can be incorporated in the processes on the servers 20 and then pushed to the operators in the field. FIG. 20 shows how the server 20 receives information from third party sources that can add value to the whole process, examples of such information can be traffic data, safety and security information, sales data coming from different sources, etc. Such information is then analyzed by an expert and accepted or not to be incorporated in the WEB and/or pushed into the mobile devices to be immediately used in the field. FIG. 21 illustrates how the server can display all the analysis, real time information, comparatives, charts, and suggest decisions either through web services directly or in authorized mobile handheld transmitter/receivers 10.

The present invention may be embodied in other specific forms without departing from its structures, methods, or other essential characteristics as broadly described herein and claimed hereinafter. The described embodiments are to be considered in all respects only as illustrative, and not restrictive. The scope of the invention is, therefore, indicated by the appended claims, rather than by the foregoing description. All changes that come within the meaning and range of equivalency of the claims are to be embraced within their scope.

I claim:

1. A method for computer guided geocoded route service sales and deliveries optimizing geomarketing financial and sales and improved logistics of a provider comprising:
providing route delivery and sales operators of delivery vehicles with computer signal transmitters/receivers, which in one mode allow each operator to receive and record latitude and longitude signals corresponding to point of interest and/or customer exact location and relate to that particular location sales, delivery, client, competitors, safety, security, financial and other marketing information, concerning customer, market and distribution points of interest along an operator's route, and in another mode receives and displays to each respective operator pricing, and marketing information, optimal routes, and other related information concerning each point of interest as the operator reaches a particular latitude and longitude of a point of interest hence allowing him to perform or not a certain activity;
providing a computer signal interface to receive and transmit geocoded signals to and from the signal transmitters/receivers to a data base of a computer server;
inputting a navigational—marketing—selling and auditing featured computer program into a third party or a providing computer server to computer translate geocoded received information by selective criteria for each point of interest to generate a customized logistic, marketing, financial and/or sales program on the third party or the providing computer server, device and/or website for each point of interest along with optimal routing information; and
transmitting the customized logistic, marketing, financial and/or sales program and optimal routing information to each route delivery and sales operators' computer signal transmitters/receivers for display or not, as the operator reaches a point of interest.

2. A method for computer guided geocoded route service sales and deliveries optimizing geomarketing, financial and sales and improved logistics of a provider according to claim 1, wherein the transmitters/receivers include navigational software positioning systems and display screens to conduce operators through the correct route to reach each point of interest.

3. A method for computer guided geocoded route service sales and deliveries optimizing geomarketing, financial and sales and improved logistics of a provider according to claim 2, wherein the navigational—marketing—selling and auditing featured computer program are carried by a mobile phone network to the transmitters/receivers which in turn record and upload the location, along with all the driving, promotional, sale and economic activities performed to a dedicated WEB page that has maps along with the capacity to analyze, query and depict the portrayed information individually or in conjunct.

4. A method for computer guided geocoded route service sales and deliveries optimizing geomarketing, financial and sales and improved logistics of a provider according to claim 3, wherein the customized marketing, financial and sales program and optimal routing information is tiered with different layers of information for selective access by different users in accordance with different levels of access authorization.

5. A method for computer guided geocoded route service sales and deliveries optimizing geomarketing, financial and sales and improved logistics of a provider according to claim 4, including electronic devices with displays, which access the third party or the providing computer server, device and/or website to display authorized levels of the customized marketing and sales program and optimal routing information.

6. A method for computer guided geocoded route service sales and deliveries optimizing geomarketing, financial and sales and improved logistics of a provider according to claim 1, including transmitting the customized marketing, financial and sales program and optimal routing information to each customer through a WiFi, GPRS or GSM signal to computer signal transmitter/receivers and also to depict it in a customized web page along with several kinds of charts and reports and send them back to computer signal transmitters/receivers or computers.

7. A method for computer guided geocoded route service sales and deliveries optimizing geomarketing financial and sales and improved logistics of a provider according to claim 1, including collecting data of the activities of the delivery, marketing, financial and sales operators to audit the daily work of the operators.

8. A method for computer guided geocoded route service sales and deliveries optimizing geomarketing, financial and sales and improved logistics of a provider according to claim 1, including using geocoded information to design, in relation to a particular characteristic of a geographic or location based market, the correct volume and portfolio mix of products and/or services that should be offered in any given particular location.

9. A method for computer guided geocoded route service sales and deliveries optimizing geomarketing, financial and sales and improved logistics of a provider according to claim 8, wherein the portfolio mix of products and/or services are transmitted and received in real time along with the response of the customer to that offer.

10. A method for computer guided geocoded route service sales and deliveries optimizing geomarketing, financial and sales and improved logistics of a provider according to claim 1, including:
allowing the operator at a point of interest to offer credit terms by prompting the server for a customized credit proposal,
sending sales data to the server, which runs algorithms including risk assessment analysis considering recent economic geographic and socio-demographic data to determine client approval and amount of credit authorized, or otherwise refuses credit,
sending the result of the risk assessment analysis to a third party lender via a third party server that decides whether or not to authorize the credit solicitation and sends a response to the operator's transmitter/receiver if credit is authorized, and
transmitting funds by the third party lender to the provider for the customer credit sales.

11. A method for computer guided geocoded route service sales and deliveries optimizing geomarkeing, financial and sales and improved logistics of a provider according to claim 10, including receiving and recording the exact location of credit solicitations and offers.

12. A method for computer guided geocoded route service sales and deliveries optimizing geomarketing financial and sales and improved logistics of a provider according to claim 1, including assigning a secure location for the operator to deposit collected cash from customer sales in an authorized depository.

13. An apparatus for computer guided geocoded route service sales and deliveries optimizing geomarketing, financial and sales and improved logistics of a provider comprising:
a. computer signal transmitters/receivers provided to route delivery and sales operators of delivery vehicles,
which in one mode allows each operator to receive and record latitude and longitude signals corresponding to points of interest and/or customer's exact location, and receive customized locational input sales, delivery, client, competitors, safety, security, financial and other marketing information, concerning customer, market and distribution points of interest along an operator's route, and in another mode receives and displays to each respective operator pricing, and marketing information, optimal routes, and other related information concerning each point of interest only as the operator reaches a particular latitude and longitude of a point of interest;
b. a computer signal interface to receive and transmit geocoded signals to and from the signal transmitters/receivers,
c. a client data base to store the geocoded signals and geocoded related information,
d. a computer server operably associated with the client data base to selectively manipulate the client data base inputs,
e. a geocoded computer program inputted into the computer server to computer translate the geocoded signals by selective marketing criteria for each point of interest to generate customized marketing and sales program outputs for the points of interest along with optimal routing information; and
f. transmission means associated with the computer server to transmit the customized marketing and sales program and optimal routing information outputs to the route delivery and sales operators' computer signal transmitters/receivers for display as the operator reaches each point of interest.

14. An apparatus for computer guided geocoded route service sales and deliveries optimizing geomarketing, financial and sales and improved logistics of a provider of claim 13, wherein the transmitters/receivers include navigational software positioning systems and display screens to conduce operators through the correct route to reach each point of interest aid operators in interpreting routing information.

15. An apparatus for computer guided geocoded route service sales and deliveries optimizing geomarketing, financial and sales via improved logistics of a provider of claim 14, wherein the navigational—marketing—selling and auditing features are carried by a mobile phone network to the transmitters/receivers which in turn records the location, along with all the driving, promotional, sale and economic activities performed and uploads it using the same carrier to a dedicated WEB page that has maps along with the capacity to analyze, query and depict the portrayed information individually or in conjunct.

16. An apparatus for computer guided geocoded route service sales and deliveries optimizing geomarketing financial and sales and improved logistics of a provider of claim 13, including electronic transmitters to transmit the customized marketing and sales program and optimal routing information to each customer's website.

17. An apparatus for computer guided geocoded route service sales and deliveries optimizing geomarketing financial and sales and improved logistics of a provider of claim 16, wherein the customized marketing and sales program and optimal routing information is tiered with different layers of information for selective access by different users according to different levels of access authorization.

18. An apparatus for computer guided geocoded route service sales and deliveries optimizing geomarketing financial and sales and improved logistics of a provider of claim 10, including electronic devices with displays, which access a customer website on the computer server for each point of interest to display authorized levels of the customized marketing and sales program and optimal routing information.
